(19) United States
(12) Patent Application Publication
(10) Pub. No.: US 2002/0076116 A1
(43) Pub. Date: Jun. 20, 2002

(54) Fast implementation of homomorphic filters for image enhancement

(75) Inventor: Reiner Eschbach, Webster, NY (US)

Correspondence Address: Albert P. Sharpe, III, Esq., Fay, Sharpe, Fagan, Minnich & McKee, LLP, 1100 Superior Avenue, 7th Floor, Cleveland, OH, 44114-2518, US

(73) Assignee: XEROX CORPORATION

(21) Appl. No.: 09/737,512

(22) Filed: Dec. 15, 2000

(51) Int. Cl. G06K 9/36; G06K 9/40; G06T 5/10; G06T 5/50

(52) U.S. Cl. 382/260; 382/264; 382/280; 382/274

(57) ABSTRACT

A method for fast implementation of a homomorphic filtering operation is disclosed. The method includes receiving an input image having an illumination component and an object component. The input image is subsampled to obtain a subsampled image. The subsampled image is processed to obtain a reduced-size image of a lightsource component of the subsampled image. A full-scale image of the lightsource component of the subsampled image is derived, and the full-scale lightsource image is subtracted from or divided through the input image to reduce the effect of the illumination component in the input image. The filtering operation is preferably carried out in the frequency domain owing to the need for a filter that encompasses the entire subsampled image. The low-frequency nature of the reduced-size lightsource image allows for safe interpolation of same to obtain a full-scale image of the lightsource.

### BACKGROUND OF THE INVENTION

The present invention relates to the digital image processing arts. More particularly, the present invention relates to a method for fast implementation of homomorphic filters to enhance digital images that have strong local imbalances in exposure. The subject invention differs significantly from conventional homomorphic filtering in that low-pass filtering is used to derive or estimate an image that represents the light source in an input image. This low-pass lightsource image is used to derive an enhanced version of the input image wherein the influence of the lightsource is dampened.

Homomorphic filters are well known and used in digital image enhancement and restoration to eliminate or at least attenuate strong local imbalances in exposure. Such exposure imbalances occur, for example, when a first portion of an object featured in an image is strongly illuminated, and a second portion of the object is hidden in a dark shadow. Such an image is sub-optimal and it has been deemed highly desirable to enhance the image so that the object appears more evenly illuminated. Homomorphic filters are described, for example, in the following references that are hereby expressly incorporated by reference: (i) Gonzales and Woods, Digital Image Processing, p213ff, Addison Wesley 1993, ISBN 0-201-50803-6; and, (ii) Ekstrom, Digital Image Processing Techniques,p41ff, Academic Press 1984, ISBN 0-12-236760-X.

Homomorphic filters are based upon the assumption that the light distribution in a recorded image is defined by a multiplication of the reflectance of the objects and the scene illumination, i.e., image (i)=light(l)*object(o). Taking the logarithm, this can be expressed in the density domain as ln(i)=ln(l) +ln(o), thereby creating a new image description, where the illumination can be expressed using the formalism of “additive noise”. Assuming that the illumination is low-pass or low-frequency with regard to the object, itself, one can perform a high-pass or band-pass filtering operation to dampen the effects of the illumination without noticeably impacting the object appearance. However, to be effective, the filter must extend over the entire image, since the illuminant variation extends over the entire image. At modern image resolutions of 300 or 600 dots per inch (dpi) or more, this filtering operation amounts to fast Fourier transforms FFT's of sizes 1000×1000 to 6000×6000 pixels, keeping in mind that the resolutions might further increase due to technology advances. The state of the art approach to homomorphic filtering cannot presently be implemented efficiently in printing and copying environments.

Standard homomorphic filters operate in line with the foregoing description. It is assumed that the image contains multiplicative contributions from the objects in the scene and the illumination according to:

i(x,y)=o(x,y)*l(x,y), (1)

where o(x,y) represents the object and l(x,y) the lightsource. The intention of homomorphic filtering is to divide the lightsource out of the equation. To do this, one must have a good understanding of the unknown lightsource. A good assumption is the low-pass nature of the light source, and this forms the basis for homomorphic filters. In essence, the homomorphic filter divides the image by a low-pass version of same. Using logarithms, this can be expressed as follows:

ln(i)=ln(o)+ln(l) (2)

to which a high-pass or band-pass filter h is applied, giving a new output image i′ according to:

ln(i′)=h\mathring{×}ln(o)+h \mathring{×}ln(l) (3)

Assuming the lightsource component I has low frequency characteristics, ln(l) also has low frequency characteristics. A properly designed filter would h would dampen the effect of the illumination in the image with respect to the object.

Since the illumination is assumed to have low-pass characteristics, the filter needs to be high-pass or band-pass with sufficiently large spatial support to cover the variations of the illuminating lightsource. This leads to the common implementation of the above equation by way of a Fourier transform and multiplication with H according to:

FT{ln(i′)}=H*FT{ln(o)}+H*FT{ln(l)} (4)

which allows filters that cover the entire image size. It should be noted that it is the need of a large filter support that is driving the frequency domain implementation, rather than dividing the data of the image by its low-pass part.

Using the assumption

0≈|H*FT{ln(l)}|<<|H*FT{In(o)}|≈|FT{ln(o)}|

leads to

i′(x,y)≅e^{h\mathring{×}ln{o(x,y)}} or i′(x,y)≅o(x,y) (5)

This, in turn, shows that the homomorphic filter has effectively divided the lightsource contributions out of the image. It should be clear that certain contributions of the lightsource are still in the image, whereas certain contributions of the object are no longer present, based upon the quality of the filter choice.

Although homomorphic filtering can have a strongly positive impact on perceived image quality, the need to Fourier transform and filter large images and thus the relatively slow processing throughput, has negatively impacted its uses. Standard techniques to increase the speed processing such as sub-sampling can not be applied for morphological filtering. The reason is that the result of the filtering is a high pass version of the input. In sub-sampled image processing, the sub-sampled result needs to be up-sampled to get the final result. Up-sampling of high pass data is extremely unreliable and noise sensitive. Consequently, common sub-sampling techniques can not be applied in the described method.

In light of the foregoing deficiencies and others associated with conventional implementation of homomorphic filters, a need as been identified for a new and improved method for fast implementation of homomorphic filters for image enhancement.

### SUMMARY OF THE INVENTION

In accordance with the present invention, a method for simulating the effect of a homomorphic filtering operation to enhance an input image includes receiving input data that define an input image. Lightsource data that represent an image of the lightsource in the input image are derived from the input image. Enhanced data that represent an enhanced image are derived by removing the effect of the lightsource data from the input data. The lightsource data are preferably derived by sub-sampling the input data, low-pass filtering the sub-sampled image, and interpolating the low-pass filtered image to full-scale. The effects of the lightsource data are removed from the input data by a division operation or by subtraction in the density domain.

In accordance with another aspect of the present invention, an input image is received that has an illumination component and an object component. The input image is sub-sampled to obtain a subsampled image. The subsampled image is processed to obtain a reduced-size image of a lightsource component of the subsampled image. A full-scale image of the lightsource component of the subsampled image is then derived, and the full-scale image of the lightsource is used to reduce or dampen the effect of the illumination component in the input image.

One advantage of the present invention resides in the provision of a method for fast implementation of homomorphic filters for digital image enhancement.

Another advantage of the present invention is found in the provision of a method for fast implementation of homomorphic filters for image enhancement that is faster than conventional homomorphic filtering with comparable results.

A further advantage of the present invention is found in the provision of a method for fast implementation of homomorphic filters for image enhancement wherein filtering is applied to a subsampled image without undesired loss of image information.

Still another advantage of the present invention resides in the provision of a method for fast implementation of homomorphic filters for image enhancement wherein a small size FFT with subsequent up-interpolation and division are implemented to approximate a standard homomorphic filter.

Still other benefits and advantages of the invention will become apparent to those of ordinary skill in the art to which the invention pertains upon reading and understanding this specification.

### BRIEF DESCRIPTION OF THE DRAWINGS

The present invention comprises various steps and arrangements of steps, preferred embodiments of which are illustrated in the accompanying drawings that form a part hereof and wherein:

FIG. 1 is a diagrammatic illustration of a digital image processing apparatus adapted for implementing a method for fast implementation of homomorphic filters for image enhancement in accordance with the present invention;

FIG. 2 is a flow chart that discloses a method for fast implementation of homomorphic filters for image enhancement in accordance with the present invention;

FIG. 3 is a more detailed flow chart disclosing the method of FIG. 2.

### DETAILED DESCRIPTION OF THE PREFERRED EMBODIMENT

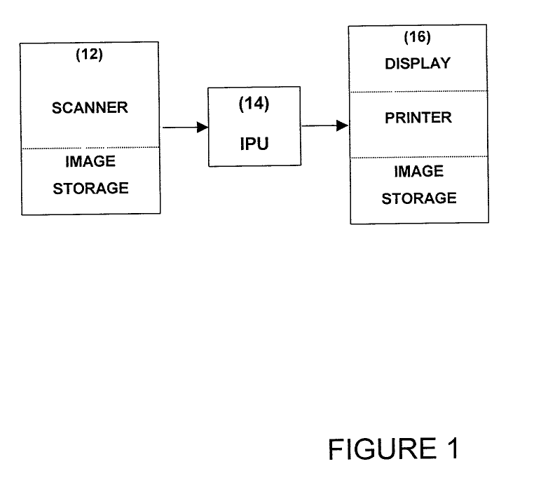

Referring now to the drawings wherein the showings are for purposes of illustrating a preferred embodiment of the invention only and not for limiting the invention in any way, FIG. 1 diagrammatically illustrates an image processing apparatus adapted for implementing a method for fast implementation of homomorphic filters in accordance with the present invention. In this example, the image processing apparatus comprises an image input terminal 12, an image processing unit 14, and an image output terminal 16. The input terminal can be any source of digital image data including a scanner or a source of stored image data. The image processing unit (IPU) is provided by any suitable electronic computing apparatus including a microprocessor or the like for carrying out digital image processing as described herein. Image data from the input terminal 12 are supplied to the IPU 14 for processing. After processing the data, the IPU 14 outputs the data to the image output terminal 16 that comprises a non-impact printer, video display, image storage device or the like. Suitable image processing apparatus including an input terminal 12, an image processing unit 14 and an image output terminal 16 are provided by digital xerographic image processing apparatus such as XEROX DocuTech document reproduction system or a conventional computer including a scanner, and a printer operatively connected thereto.

With the above-noted deficiencies of conventional homomorphic filtering in mind, the present invention is directed to a method that utilizes a low-pass filter rather than a high-pass or band-pass filter to separate the image of the object from the image of the lightsource. Use of a low-pass filter is critical so that filtering can be performed safely on a subsampled image, and wherein the filtered image can be up-interpolated to derive a full-scale image. Thus, according to the present invention, an intermediate function with low-pass characteristics is created, so that it may be safely up-interpolated to derive a full scale image of the lightsource.

In the preferred embodiment, this is accomplished by a filter H′ that is equal to the inverse of the filter H described above, i.e., H′=1-H. Using this new filter, equation (4) above is rewritten as:

FT{ln(i′)}=(1-H)*FT{ln(o)}+(1-H)*FT{ln(l)} (4a)

Since the filter H was said to be high-pass or band-pass, the new filter H′ is low-pass, and the following relationship holds:

|FT{ln(l)}|≈|H*FT{ln(l)}|>>|H*FT{ln(o)}|≈0

Those of ordinary skill in the art will recognize that this is the reverse relationship to that associated with conventional homomorphic filters as described above. This, then, leads to a change in equation (5) above so that:

i′≅e^{h\mathring{×}ln(l)} or i′≅l (5a)

Equation 5 represents the homomorphic approximation of the light source. The main difference between eqs.(5) and (5a) is that eq.(5) attempts to approximate the object signal, a high pass signal, whereas eq.(6) attempts to approximate the light source signal, a low pass signal, from the recorded image signal i. In this case, i′ has low-pass characteristics and can easily be interpolated using standard up-sampling methods. In contrast to eq.(5), eq.(5a) does not yet represent the final output of the method. The final output is then obtained by:

i″=i/i′=o*l/i′=o (6)

Thus, it can be seen that the image i″ corresponds to the original image i or (o*l) divided by the lightsource image i′ which results in the image of the object o, which is the desired output of a homomorphic filtering operation. It should be noted that the low pass characteristics of i′ also allow the prevention of singularities in eq.(6) by enforcing i′>0 .

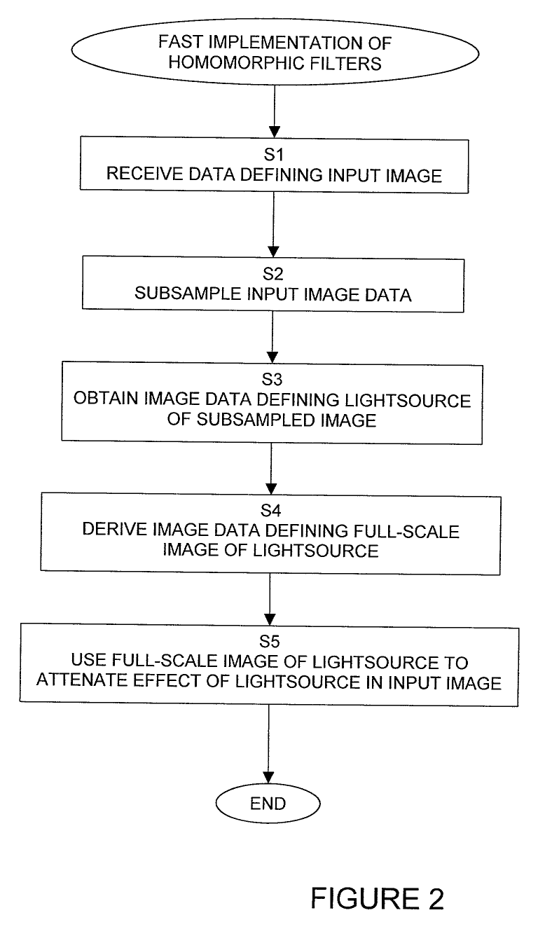

The method for fast implementation of homomorphic filters in accordance with the present invention is disclosed generally in FIG. 2. Those of ordinary skill in the art will recognize that the method is suitable for enhancing digital images wherein a strong shadow is present and obscures a portion of the object(s) intended to be shown.

The method comprises a step S1 of receiving image data defining an input image i in need of homomorphic filtering. A step S2 subsamples the image data defining the input image so that image data defining a subsampled image is obtained. By definition, the subsampled image is smaller is size than the input image and, thus, is more suitable for high-speed processing as required in a printing, digital photography, or xerographic environment. The step S2 can be accomplished according to any suitable subsampling operation with or without a prefiltering step. Where processing speed is critical, it is most preferred that the data defining the input image be directly subsampled without a prefiltering operation. This can generally be done safely without loss of critical image information owing to the fact that the subsampled image is later low-pass filtered as described below.

A step S3 processes the subsampled image to extract or derive data that define an image of the lightsource from the subsampled image. At this stage, the image of the lightsource is equal in size to the subsampled image. Thus, a step S4 is carried up to derive data that represent a full-scale image i′ of the lightsource, i.e., an image of the lightsource that is equal in size to the input image.

A step S5 uses the data defining the full-scale image i′ of the lightsource to operate on the data that define the input image i to attenuate the effect of the lightsource in the input image i, i.e., to output the image i″=o.

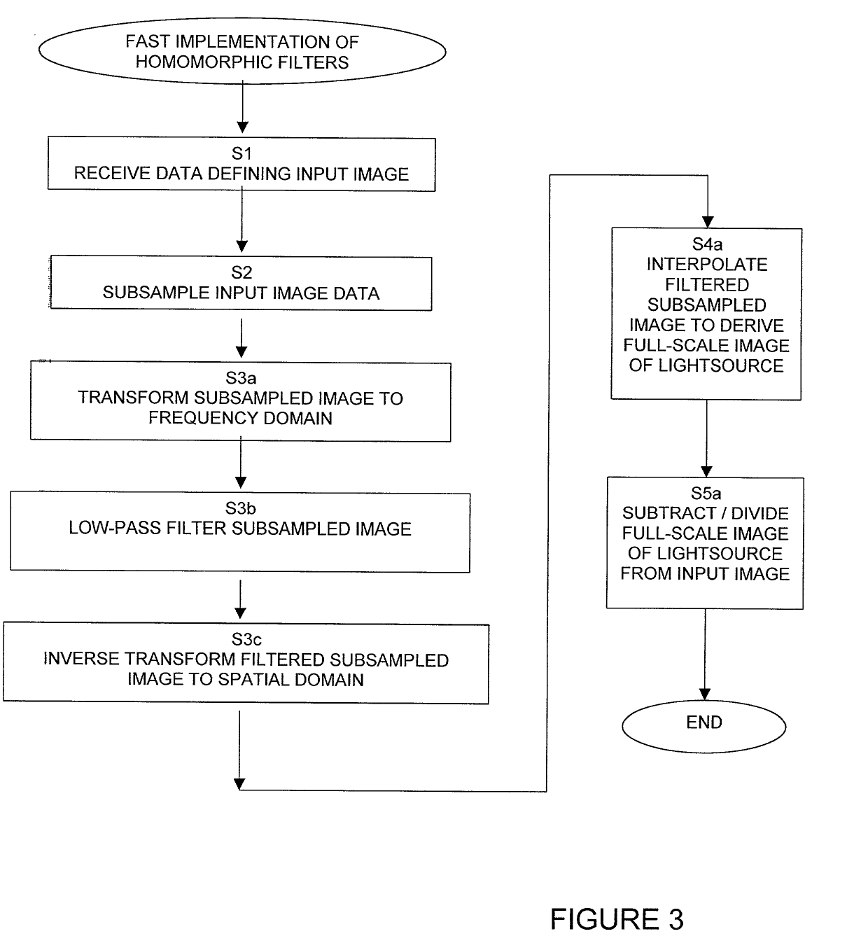

Referring now to FIG. 3, a preferred embodiment of the foregoing method is described in further detail. The data defining the input image i are received S1 and subsampled S2 as described above. To implement the step S3 of obtaining image data defining an image of the lightsource from the subsampled image, steps S3a-S3c are preferably implemented. The step S3a comprises performing a Fourier transform to move the image data defining the subsampled image into the frequency domain. A step S3b low-pass filters the subsampled frequency domain image data, and a step S3c transforms the low-pass filtered data back to the spatial domain. The steps S3a-S3c can be replaced by a step of low-pass filtering the subsampled image in the spatial domain. However, owing to the fact that the low-pass filter preferably spans the entire image to properly obtain an output image of the light source, those of ordinary skill in the art will recognize that processing in the frequency domain is generally preferred.

The step S4 of deriving image data defining a full-scale image i′ of the lightsource preferably comprises a step S4a of interpolating the image data defining the filtered, subsampled image. Although any interpolation method (e.g., nearest neighbor) may be used, it is preferred that the resulting full-scale image be low-frequency. Thus, it is most preferred to interpolate using a normal linear interpolation or other low-order interpolation method as opposed to a high-order polynomial interpolation scheme.

The step S5 of using the image data defining the full-scale image of the lightsource i′ to attenuate the effect of the lightsource in the input image i is preferably carried out by a step S5a that comprises dividing the image data defining the input image i by the data defining the lightsource image i′. Of course, this has the same effect of a subtraction of the image i′ from the image i in the density (logarithmic) domain. Alternatively, the full size approximation of the light source l can be used in eq.(2) after transforming both i and l into the logarithmic domain, followed by subtraction and reverse transform. The result of the step S5a is image data defining the image o of the object.

Modifications and alterations will occur to those of ordinary skill in the art to which the invention pertains upon reading this specification. It is intended that all such alterations and modifications fall within the scope of the invention as defined by the following claims as construed literally or according to the doctrine of equivalents.

Having thus described the preferred embodiments, what is claimed is:

1. A method for simulating the effect of a homomorphic filtering operation to enhance an input image, said method comprising:
receiving input data that define an input image;
deriving from said input data lightsource data that represent an image of a lightsource in said input image;
deriving enhanced data that represent an enhanced image, said enhanced data obtained by removing the effect of said lightsource data from the input data.

2. The method as set forth in claim 1, wherein said step of deriving lightsource data comprises:
subsampling said input data to obtain subsampled data defining a subsampled image;
low-pass filtering said subsampled data; and,
upsampling said low-pass filtered data to derive said lightsource data that define a full-scale image of said lightsource.

3. The method as set forth in claim 2, wherein said step of low-pass filtering comprises:
performing a Fourier transform operation on said subsampled data to define said subsampled data in a frequency domain;
low-pass filtering said subsampled data in the frequency domain; and,
performing an inverse of said Fourier transform operation on said low-pass filtered subsampled data to define said low-pass subsampled data in a spatial domain.

4. The method as set forth in claim 1, wherein said step of deriving enhanced data comprises subtracting said lightsource data from said input data.

5. The method as set forth in claim 1, wherein said step of deriving enhanced data comprises dividing said input data by said lightsource data.

6. The method as set forth in claim 2, wherein said step of upsampling said low-pass filtered data to derive said lightsource data that define a full-scale image of said lightsource comprises interpolating said low-pass filtered data using a linear interpolating method.

7. In a xerographic or other non-impact printing environment, a method for enhancing a digital image exhibiting uneven exposure, said method comprising:
receiving input data that define an input image that exhibits uneven exposure;
deriving from said input data lightsource data that represent an image of a lightsource in said input image;
deriving enhanced data that represent an enhanced image, said enhanced data obtained by removing the effect of said lightsource data from the input data.

8. The method as set forth in claim 7, wherein said step of deriving lightsource data comprises:
subsampling said input data to obtain subsampled data defining a subsampled image;
low-pass filtering said subsampled data; and,
upsampling said low-pass filtered data to derive said lightsource data that define a full-scale image of said lightsource.

9. The method as set forth in claim 8, wherein said step of low-pass filtering comprises:
performing a Fourier transform operation on said subsampled data to define said subsampled data in a frequency domain;
low-pass filtering said subsampled data in the frequency domain; and,
performing an inverse of said Fourier transform operation on said low-pass filtered subsampled data to define said low-pass subsampled data in a spatial domain.

10. The method as set forth in claim 7, wherein said step of deriving enhanced data comprises subtracting said lightsource data from said input data.

11. The method as set forth in claim 7, wherein said step of deriving enhanced data comprises dividing said input data by said lightsource data.

12. The method as set forth in claim 8, wherein said step of upsampling said low-pass filtered data to derive said lightsource data that define a full-scale image of said lightsource comprises interpolating said low-pass filtered data using a linear interpolating method.

13. A method for fast implementation of a homomorphic filtering operation, said method comprising:
receiving an input image having an illumination component and an object component;
subsampling said input image to obtain a subsampled image;
processing said subsampled image to obtain a reduced-size image of a lightsource component of said subsampled image;
deriving a full-scale image of said lightsource component of said subsampled image;
using said full-scale image of said lightsource to reduce an effect of said illumination component in said input image.

14. The method as set forth in claim 13, wherein said step of using said full-scale image of said lightsource to reduce an effect of said illumination component in said input image comprises:
subtracting said full-scale image of said lightsource from said input image.

15. The method as set forth in claim 13, wherein said step of using said full-scale image of said lightsource to reduce an effect of said illumination component in said input image comprises:
dividing said input image by said full-scale image of said lightsource.
